(19) United States
(12) Patent Application Publication
(10) Pub. No.: US 2011/0187680 A1
(43) Pub. Date: Aug. 4, 2011

(54) Device to aid in texting on a cell phone

(76) Inventor: Norman Samol, Naples, FL (US)

(21) Appl. No.: 12/657,971

(22) Filed: Feb. 1, 2010

(51) Int. Cl. G06F 3/033

(52) U.S. Cl. 345/179

(57) ABSTRACT

The invention represents a device which is used on one or more fingers when texting on a cell phone having small or tiny keys. The device consists of a U-shaped rings having its ends back bent to act as pressure points when the U-shaped ring is placed on a finger. The device at its apex and on the outside has a protrusion or a knob thereon which is instrumental to touch the small keys. When the device is placed on a finger the knob is located against the flesh of the finger under the finger nail. The knob or protrusion can represent an ornamental design to enhance the appearance of a hand when the device is placed on a finger with the nob pointing outwardly when the device is not in use.

### BACKGROUND OF THE INVENTION

Cell phone numbers and letters therein are getting smaller an narrower all the same making accurate texting extremely difficult because the size of any finger excedes the size of any of the keys, whereby many times two or more keys are hit or touched. It is therefore very desirable to have a device on one or more fingers or thumb that presents a small or narrow contact point, whereby the accuracy of texting is greatly increased. There are known and various devices that are worn on a finger to present a small or narrow contact point to operate certain instruments. Theses are known as picks to strum a guitar or they are also used on a zither.

U.S. Pat. No. 4,015,502. Discloses a pick to be used by musicians while playing a guitar or a an electric guitar. The device is made of wire that has a forward end in the form of a narrow U shape. It is possible that this device could be used for texting but there is no suggestion therein to do so.

U.S. Pat. No. 4,102,480 is a device that is worn on a finger as an aid to guide a needle. There is not forward end thereon. The device consists of a guitar pick that is flexed to a ring on a finger.

U.S. Pat. No. 4,998,651 illustrates a needle guide consisting of ring worn on a finger that has a side extension to push needles therewith.

U.S. Pat. No. 5,973,243 discloses a guitar pick that is attached to a finger by way of a flexible ring. The guitar pick blade is supported between two fingers and could not be used as a device for texting.

U.S. Pat. No. 7,188,756 shows a device on a flexible ring that has a side extension or protruberance that is adapted to carry sewing needle.

U.S. Pat. No. 7,312,386 Illustrates a flexible ring worn on a finger that has a pointed side extension that is as a guitar or zither pick.

### BRIEF DESCRIPTION OF THE INVENTION

The inventive concept lies in the discovery that a small, flexible and narrow U shaped ring could be attached to finger with a pointed end thereon that could be used to hitting the keys on a cell phone. The device is narrow enough so that it or more could be stored on finger until required for use. This device could not be used for picking the strings on a guitar because the pointed end is pointing in the wrong direction to be useful on a guitar.

### BRIEF DESCRIPTION OF THE DRAWINGS

FIG. 1 is a cross section through the texting device;

FIG. 2 is a top view with the texting device in a stored mode;

FIG. 3 shows the texting device installed on a finger;

FIG. 4 is a front view of the installed texting device;

FIG. 5 is a different embodiment with the texting principle applied to a thimble.

### DETAILED DESCRIPTION OF THE INVENTION

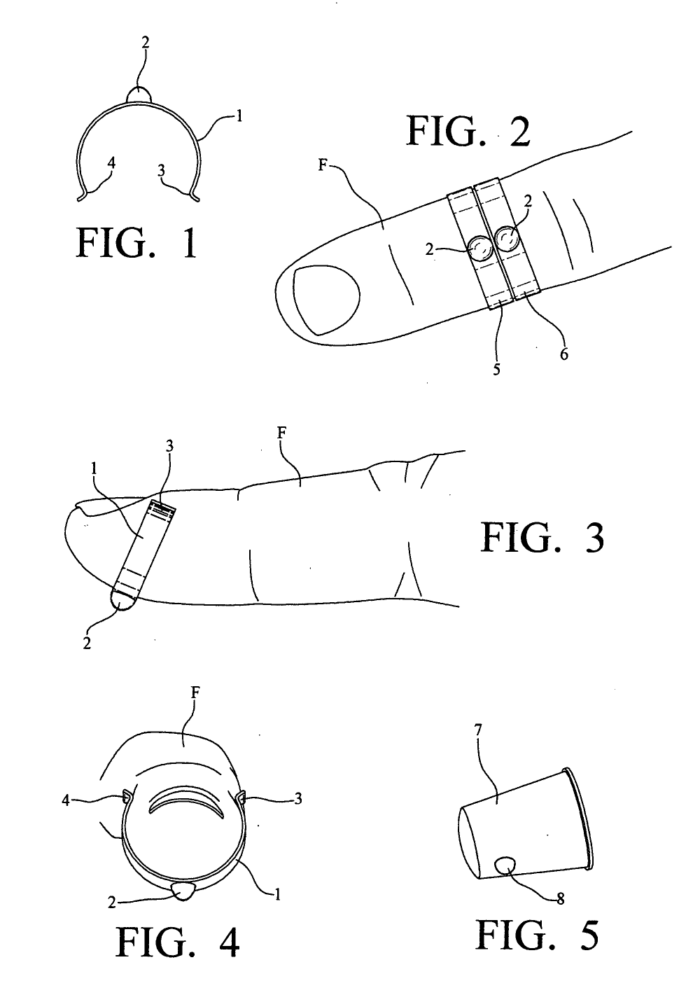

As explained above, Fig. illustrates a cross section through the texting device. The device is preferably made of a plastic material but not limited to plastic and is constructed as a narrow substantially U-shaped ring. The U-shaped ring 1 is so constructed that it has a tendency for the ends of the U-shaped ring 1 to converge toward each other. In other words, when the device is placed on a finger it will clamp itself thereon. The ends of the U-shaped ring 1 are somewhat bent outwardly to create a pressure point against the sides of a finger. The bent outwardly portions in FIG. 1 can be seen as 3 and 4. Theses outwardly bent portions themselves resemble small U shapes. The device is also placed on a finger below the fingernail against the flesh there under. The texting device has a protrusion 2 thereon that is instrumental in touching the narrow keys on the cell phone. The protrusion or knob 2 can be part of the device 1 when manufactured or it can be added later on. It could represent an ornamental design to give the device a neat appearance when placed on a finger as is shown in Fig. FIG. 2 shows a finger F having two texting devices 5 and 6 placed thereon in storage. That is, when not in use the texting device or two can be stored on a finger. This way the user does not have to look for the devices when a use is required. This avoids digging through pockets or handbags or leaving or forgetting the devices at home when leaving the same. The knobs or protrusions on the apex of the texting device are especially decorative when placed side-by-side, again as shown in FIG. 2.

FIG. 3 illustrates the texting device after having placed on a finger F. As can be seen in this FIG. 3, the open ends of the device embrace the sides of the finger F and stay there because of the tension in the U-shaped form. At 3 there is shown the bent back portion at the end of the ring which, as mentioned above create a pressure point at the side of the Finger F in conjunction with other bent back portion 4 on the other side of the Finger F. The knob or protrusion 2 is located somewhat under the fingernail of the finger F and is resting against the flesh of the finger F which also is located under the fingernail.

FIG. 4 shows a front view of the texting device 1 installed on a finger F. The bent back portions 3 and 4 can be seen as pressing against the side of the finger F to keep it in place. Also, the protrusion or knob 2 can be seen as being placed against the flesh of the finger F and under the finger nail.

FIG. 5 illustrates a different embodiment. This embodiment shows a regular sewing thimble 7 that has placed thereon a knob 8. While it is a little more awkward to use when texting, it solves the same problem and, that is to avoid hitting more than one key when sending a text message.

### Operation

When sending a text message on a cell phone that has small or tiny keys it is desirable to wear a texting device. The texting device consists of a U-shaped ring that has the ends of the U bent back to create a pressure point against the sides of a finger. The U-shaped ring has at its apex and on the outside located a protrusion or a knob that can touch any of the keys when texting without hitting more than one key as often happens when the fingers, especially, large fingers hit the keys. One or more of these texting devices can be stored on a finger to be kept in a stand-by mode.

What I claim is:

1. A device for use when texting on a cell phone having small keys thereon, said device consisting of a U-shaped ring, said U-shaped ring is made to assert pressure against the sides of a finger when placed thereon, said U-shaped ring having at its apex and on its outside a knob thereon that, when the device is worn, is located against the flesh of a finger and under the finger nail of the finger.

2. The device of claim 1, wherein the ends of the U-shaped ring are bent back to create a pressure point against the finger.

3. The device of claim 1, wherein knob represents an ornamental design.

4. The device of claim 1, wherein two of said devices may be placed on a finger when not in use to represent normal rings with said knobs exhibiting a decoration.

5. A device for use when texting on a cell phone having small keys thereon, said device representing a sewing thimble having at an outer end and at a side thereof a knob placed thereon, said knob touching said keys one at a time.
